(19) United States
(12) Patent Application Publication
(10) Pub. No.: US 2024/0072341 A1
(43) Pub. Date: Feb. 29, 2024

(54) BATTERY PACKAGING MATERIAL

(71) Applicant: Resonac Packaging Corporation, Hikone-shi (JP)

(72) Inventors: Keitaro KAWAKITA, Hikone-shi (JP); Naoya KODA, Tokyo (JP)

(73) Assignee: Resonac Packaging Corporation, Hikone-shi (JP)

(21) Appl. No.: 18/239,076

(22) Filed: Aug. 28, 2023

(30) Foreign Application Priority Data
Aug. 29, 2022 (JP) 2022-135592
Jun. 30, 2023 (JP) 2023-108176

(51) Int. Cl. H01M 50/122; C08K 3/30; C08L 27/18; C08L 33/18; C08L 67/00; C08L 75/04; H01M 50/129; H01M 50/131

(52) U.S. Cl. CPC H01M 50/122; C08K 3/30; C08L 27/18; C08L 33/18; C08L 67/00; C08L 75/04; H01M 50/129; H01M 50/131; C08K 2003/3045

(57) ABSTRACT

A battery packaging material includes a substrate layer, a heat-fusible resin layer, a barrier layer arranged between both the layers, and a substrate protective layer arranged on an outer side of the substrate layer as an outermost layer. The substrate protective layer contains a binder resin, and solid fine particles including soft and hard resin fine particles, and inorganic fine particles. The deformation strength of the soft resin fine particles is 2 MPa or more and less than 20 MPa, that of the hard resin fine particles is 20 to 100 MPa, and the breaking strength of the inorganic fine particles is 500 to 2,000 MPa, measured in accordance with a measurement method of breaking strength and deformation strength defined in JIS Z 8844:2019. The total content of the solid fine particles in the substrate protective layer is 30 to 50 mass %.

### BACKGROUND OF THE INVENTION

### Field of the Invention

The present invention relates to a packaging material for a power storage device, such as, e.g., a battery and a capacitor, used for a mobile device including, e.g., a smartphone and a tablet computer. It also relates to a packaging material for a power storage device, such as, e.g., a battery and a condenser, used for an electric vehicle, wind power generation, solar power generation, and nighttime electricity storage.

### Description of the Related Art

The following description sets forth the inventor's knowledge of the related art and problems therein and should not be construed as an admission of knowledge in the prior art.

During a battery production process, if a surface of a packaging material, which is a case material, is damaged, the appearance of the product is impaired. In order to prevent the occurrence of poor appearance during the production process, a measure is taken in which a protective tape is adhered to the packaging material, and the protective tape is peeled off after completion of the production process. The above-described protective tape is required to have adhesion that does not allow peeling of the protective tape during the production process, but if it is strongly adhered, the adhesive of the protective tape may remain on the packaging material after removal. Further, in a packaging material in which a coloring layer containing a carbon black is laminated on a surface, the coloring layer may be peeled off along with the protective tape.

In order to deal with such a problem related to the protective tape, conventionally, the adhesive residue after removal of the protective tape was dealt with by the adhesive force of the protective tape (see Patent Document 1). Further, as for the peeling of the coloring layer, a technique for strengthening the coloring layer has been proposed (see Patent Document 2).

### PRIOR ART DOCUMENT

### Patent Document

Patent Document 1: Japanese Unexamined Patent Application Publication No. 2020-155364
Patent Document 2: Japanese Unexamined Patent Application Publication No. 2006-206805

However, the technique described in Patent Document 1 is not a preventive measure against adhesive residue in a packaging material. However, the technique described in Patent Document 2 does not solve the problem of adhesive residue for a packaging material in which the outermost layer is not a coloring layer containing a carbon black.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

In view of the background art described above, the purpose of the present invention is to impart a conflicting characteristic that the protective tape does not peel off unintentionally and can be peeled off without remaining adhesive of the protective tape on the surface of the battery packaging material and to prevent deterioration of the appearance due to the adhesive residue of the protective tape.

That is, the present invention has the configuration described in the following Items [1] to [11].

[1] A battery packaging material includes
a substrate layer,
a heat-fusible resin layer,
a barrier layer arranged between the substrate layer and the heat-fusible resin layer, and
a substrate protective layer arranged on an outer side of the substrate layer as an outermost layer,
wherein the substrate protective layer contains a binder resin and solid fine particles, the solid fine particles including soft resin fine particles, hard resin fine particles, and inorganic fine particles,
wherein a deformation strength of the soft resin fine particles is 2 MPa or more and less than 20 MPa, a deformation strength of the hard resin fine particles is 20 MPa to 100 MPa, and a breaking strength of the inorganic fine particles is 500 MPa to 2,000 MPa, the deformation strength and the breaking strength being measured in accordance with a measurement method of a breaking strength and a deformation strength defined in JIS Z 8844:2019, and
wherein a total content rate of the solid fine particles in the substrate protective layer is 30 mass % to 50 mass %.

[2] The battery packaging material as recited in the above-described Item [1],
wherein an average particle diameter of the soft resin fine particles is 5 μm to 20 μm, an average particle diameter of the hard resin fine particles is 1 μm to 15 μm, and an average particle diameter of the inorganic fine particles is 1 μm to 5 μm.

[3] The battery packaging material as recited in above-described Item [1] or [2],
wherein a content rate of the soft resin fine particles in the substrate protective layer is 1 mass % to 10 mass %, a content rate of the hard resin fine particles is 1 mass % to 20 mass %, and a content rate of the inorganic fine particles is 20 mass % to 40 mass %.

[4] The battery packaging material as recited in any one of the above-described Items [1] to [3],
wherein the soft resin fine particles are at least one selected from the group consisting of polyethylene wax, polypropylene wax, polyethylene resin beads, and urethane resin beads.

[5] The battery packaging material as recited in any one of the above-described Items [1] to [4],
wherein the hard resin particles are at least one selected from the group consisting of polytetrafluoroethylene wax, acrylic resin beads, polystyrene resin beads, and fluororesin beads.

[6] The battery packaging material as recited in any one of the above-described Items [1] to [5],
wherein the inorganic fine particles are at least one selected from the group consisting of silica, alumina, kaolin, calcium oxide, calcium carbonate, calcium sulfate, barium sulfate, and calcium silicate.

[7] The battery packaging material as recited in any one of the above-described Items [1] to [6],
wherein the binder resin is at least one selected from the group consisting of an acrylic-based resin, a urethane-based resin, a polyolefin-based resin, a phenoxy-based resin, a polyester-based resin, and a tetrafluoroolefin-based resin.

[8] The battery packaging material as recited in any one of the above-described Items [1] to [7],
wherein at least one of the substrate protective layer and the substrate layer contains a coloring agent.

[9] The battery packaging material as recited in any one of the above-described Items [1] to [7],
wherein the barrier layer and the substrate layer are laminated via an adhesive layer, and at least one of the substrate protective layer, the substrate layer, and the adhesive layer contains a coloring agent.

[10] The battery packaging material as recited in any one of the above-described Items [1] to [7],
wherein a coloring layer is arranged at least one of between the substrate protective layer and the substrate layer and between the substrate layer and the barrier layer.

[11] The battery packaging material as recited any one of the above-described Items [1] to [7],
wherein the barrier layer and the substrate layer are laminated via an adhesive layer, and the coloring layer is arranged at least one of between the substrate protective layer and the substrate layer, between the substrate layer and the adhesive layer, and between the adhesive layer and the barrier layer.

### Effects of the Invention

The battery packaging material as recited in the above-described Item [1], the substrate protective layer contains a binder resin, soft resin fine particles, hard resin fine particles, and inorganic fine particles, as solid fine particles. The soft resin fine particles, hard resin fine particles, and inorganic fine particles are different in hardness each other. Therefore, the surface is composed of a portion where the binder resin is present and a portion where the solid fine particles of the three different hardness are present. The portion where the binder resin is present is likely to be contacted by the adhesive of the protective tape and has a strong adhesive force, while the portion where the solid particles are present is less likely to be contacted by the adhesive and has a weak adhesive force. Further, since there are three types of solid particles different in hardness, the adhesive force varies depending on the solid particles as well. Further, since the total content rate of the solid particles is regulated to be between 30 mass % and 50 mass %, the area strong in adhesive force and the area weak in adhesive force are balanced, so that the protective tape can be easily peeled off after use while maintaining adhesive force when needed, and adhesive residue after removal is less likely to occur.

Further, when the battery packaging material is heated and pressurized during the curing process in the battery production, the soft resin fine particles and the hard resin fine particles soften and deform unevenly according to their deformation strength, increasing the adhesion of the protective tape, which makes it difficult to peel off. On the other hand, inorganic fine particles are very hard and hardly deformable due to the breaking strength of the particles, so the easy peeling effect is maintained, the significant deformation of the soft resin particles and the hard resin particles can be prevented, and the burial of the soft resin particles and the hard resin particles in the binder resin can be suppressed. By using three types of solid fine particles different in hardness, it is possible to reduce the increase in adhesive force due to heating and pressurization to thereby maintain the easy peeling property.

According to the battery packaging material as recited in the above-described Item [2], since the average particle diameters of the three types of solid fine particles are regulated, the timings at which the adhesive are peeled off are shifted, and therefore, cohesive breakdown of the adhesive is less likely to occur, thus preventing adhesive residue.

According to the battery packaging material as recited in the above-described Item [3], the content rates of three types of solid fine particles are regulated, and a large amount of inorganic fine particles are blended, which is highly effective in inhibiting the contact between the adhesive of the protective tape and the binder resin during the heating and pressing, thereby preventing the occurrence of adhesive residue.

According to the battery packaging material as recited in the above-described Item [4], the selected soft resin fine particles soften at the temperature at the time of heating and pressurization and become easily deformable, so that appropriate peel strength can be obtained against the adhesive of the protective tape.

According to the battery packaging material as recited in the above-described Item [5], the selected hard resin fine particles are slightly deformed by the synergistic effects of the temperature and the pressure during the heating and pressurization, which slightly increases the contact area with the adhesive of the protective tape and contributes to the peel strength of the tape.

According to the battery packaging material as recited in the above-described Item [6], the selected inorganic fine particles are hard to be deformed at the time of the heating and pressurization, so that appropriate peel strength can be obtained against the adhesive of the protective tape.

According to the battery packaging material as recited in the above-described in [7], the adhesion suitability of the selected binder resin and the adhesive of the protective tape are good, so that the adhesive force can be differentiated between the portion where the binder resin is present and the portion where the solid fine particles are present.

In the battery packaging material as recited in the above-described Items [8], [9], [10], and [11], by coloring with a coloring agent, the visibility of the adhesive residue portion of the protective tape is improved, which facilitates the determination of the adhesive residue. Furthermore, the design can be imparted.

### BRIEF DESCRIPTION OF THE DRAWINGS

The preferred embodiments of the present invention are shown by way of example, and not limitation, in the accompanying figures.

FIG. 1 is a cross-sectional view showing one example of a battery packaging material of the present invention.

FIG. 2 is a cross-sectional view showing a heated and pressurized state of the battery packaging material to which a protective tape is adhered.

FIG. 3 is a cross-sectional view showing another example of a battery packaging material of the present invention.

FIG. 4 is a cross-sectional view showing still another example of a battery packaging material of the present invention.

FIG. 5 is a cross-sectional view showing still yet another example of a battery packaging material of the present invention.

FIG. 6 is a cross-sectional view showing still further yet another example of a battery packaging material of the present invention.

FIG. 7A is a plan view of a test piece and an adhesive tape used for tape adhesion evaluation of a battery packaging material.

FIG. 7B is a diagram schematically showing a test method for a tape adhesion evaluation of a battery packaging material.

### DETAILED DESCRIPTION OF THE PREFERRED EMBODIMENTS

In the following paragraphs, some preferred embodiments of the present invention will be described by way of example and not limitation. It should be understood based on this disclosure that various other modifications can be made by those skilled in the art based on these illustrated embodiments.

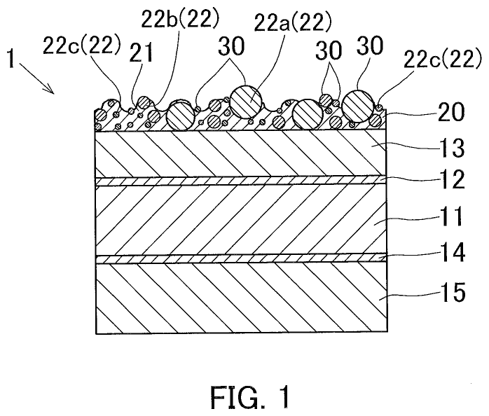

In the battery packaging material 1 shown in FIG. 1, a substrate layer 13 is laminated on one side of a barrier layer 11 via a first adhesive layer 12, a heat-fusible resin layer 15 is laminated on the other side via a second adhesive layer 14, and a substrate protective layer 20 is laminated on the substrate layer 13.

### (Use of Protective Tape in Battery Production Process)

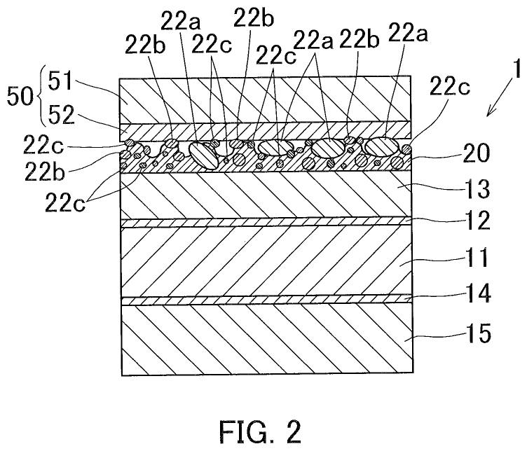

The battery case is produced by three-dimensionally molding the battery packaging material 1 to form a convex portion and placing the three-dimensionally molded battery packaging materials 1 and 1 with the heat-fusible resin layers 15 faced each other. A battery element and electrolyte are filled in the case, the perimeters of the convex portions are heat-sealed, and curing and degassing are further performed. Thus, the production of a battery is completed. In the process from molding of the battery packaging material 1 to degassing, for the purpose of protecting the battery packaging material 1, a protective tape is adhered to the top surface of the convex portion and the non-heat sealing portion, and curing and degassing are performed with the tape adhered. The curing is performed by heating to 50° C. to 80° C. and maintaining the pressurized state in which it is pressurized under 0.3 MPa to 0.7 MPa in the lamination direction for 1 hour to 24 hours. FIG. 2 shows the state in which the packaging material 1 in which a protective tape 50 is adhered is heated and pressurized. The protective tape 50 is a sheet in which an adhesive 52 is coated on one side of a substrate 51.

The cured and degassed battery will be shipped with the protective tape 50 peeled off.

Therefore, the outer surface of the battery packaging material 1 must have conflicting characteristics that the adhered protective tape 50 must be firmly attached to the outer surface of the battery packaging material 1 without causing unintentional peeling, but when the protective tape 50 becomes no longer needed, the protective tape can be cleanly detached without leaving any adhesive 52 on the adhered surface and without damaging the adhered surface.

### (Substrate Protective Layer)

The substrate protective layer 20 is a layer that imparts good slipperiness to the surface of the battery packaging material to improve moldability, as well as excellent electrolyte resistance, chemical resistance, solvent resistance, and abrasion resistance.

The substrate protective layer 20 is a cured film of a resin composition containing a binder resin 21 and three types of solid fine particles 22 described below. Some of the solid fine particles 22 in the cured film are buried in the binder resin 21, but the others protrude outward from the surface to form protrusions 30. Therefore, on the surface of the substrate protective layer 20, not only extremely fine unevenness by the binder resin 21 but also large unevenness due to the protrusions 30 are formed.

The protrusion 30 protrudes high on the surface of the substrate protective layer 20, so that the adhesive of the protective tape comes into contact with the tip of the protrusion 30 but not with the sloping portion surrounding it. On the other hand, the portions excluding the protrusions 30 are smoother than the protrusions 30 and thus easier for the adhesive to contact. The portion with which the adhesive is less likely to come into contact is less in the contact amount of the adhesive and thus weaker in the adhesive force (adhesion). On the other hand, the portion with which the adhesive is likely to come into contact is more in the contact amount of the adhesive and thus stronger in the adhesive force. As described above, the state in which the portion large in the contact amount of the adhesive and the portion small in the contact amount of the adhesive are finely mixed on the surface of the substrate protective layer 20 allows the adhesive to maintain adhesive force when necessary and causes easily peeling after use, thereby minimizing the occurrence of adhesive residue after peeling.

The substrate protective layer 20 is required to have a balance between an adhesive force when the protective tape is needed and easy peeling properties after use. This balance is affected by the composition of the resin constituting the substrate protective layer 20 and the properties of the solid fine particles to be used, and an appropriate balance can be obtained by regulating them.

The resin composition constituting the substrate protective layer 20 contains a binder resin 21 and three types of solid fine particles 22, i.e., soft resin fine particles 22a, hard resin fine particles 22b, and inorganic fine particles 22c. The three types of solid fine particles 22 differ in hardness, the soft resin fine particles 22a being the softest and the inorganic fine particles 22c being the hardest.

In the present invention, the hardness/softness of the solid fine particles is regulated by the deformation strength or the breaking strength measured in accordance with a measurement method of a breaking strength and a deformation strength of fine particles according to JIS Z 8844: 2019. In the soft resin fine particles 22a, the deformation strength is regulated to be 2 MPa or more and less than 20 MPa, and the preferred deformation strength is 3 MPa to 10 MPa. In the hard resin fine particles 22b, the deformation strength is regulated to be 20 MPa to 100 MPa, and the preferred deformation strength is regulated to be 20 MPa to 60 MPa. In the inorganic fine particles 22c, the breaking strength is regulated to be 500 MPa to 2,000 MPa, and the preferred breaking strength is 800 MPa to 1,900 MPa.

As described above, the three types of solid fine particles 22 are different in hardness, and the three types of solid fine particles 22 are different in hardness from the cured binder resin 21 as well. On the surface of the substrate protective layer 20, protrusions 30 due to the solid fine particles 22 are formed. Therefore, on the surface of the substrate protective layer 20, there exist portions different in hardness due to the binder resin 21 and the three types of solid fine particles 22. The separation easiness of the adhesive of the protective tape differs depending on the hardness of the adhering surface. The portion where the binder resin 21 is present easily comes into contact with the adhesive of the protective tape and has a strong adhesive force, while the portion where the solid fine particles 22 are present is less likely for the adhesive to come into contact with and has a weak adhesive force. Furthermore, since there are three types of solid fine particles 22 different in hardness, the strength of the adhesive force varies depending on the solid fine particles 22 as well. When the protective tape is peeled off from the substrate protective layer 20 having the described surface, the peeling timings of the adhesive shift at portions different in hardness, and the force applied to the adhesive is distributed, so that cohesive breakdown of the adhesive is unlikely to occur, resulting in less occurrence of adhesive residue.

Further, as shown in FIG. 2, the curing performed by heating and pressurizing after heat sealing in the battery production process is performed in a state in which the protective tape 50 is adhered to the battery packaging material 1. Pressurizing the battery packaging material 1 in the lamination direction while heating causes changes according to their characteristics in each of the three types of solid fine particles.

The soft resin fine particles 22a soften and deform into a flat shape upon heating and pressurization, increasing the contact area with the adhesive 52 to improve the adhesion of the protective tape 50, which results in hard to peel off.

The hard resin fine particles 22b also soften, but the degree of deformation is smaller than that of the soft resin fine particles 22a, so the increase in the contact area with the adhesive 52 is commensurate, and the effect of increasing adhesion is smaller than that of the soft resin fine particles 22a.

The inorganic fine particles 22c are very hard and hardly deformable. Therefore, there is no change in the contact area with the adhesive 52, and the easy peeling effect due to the protruding particles (protrusions 30) is maintained. Further, the inorganic fine particles 22c prevent significant deformation of the soft resin fine particles 22a and the hard resin fine particles 22b, and also prevent the soft resin fine particles 22a and the hard resin fine particles 22b from being buried in the binder resin 21.

Although the adhesive force of the protective tape 50 increases when the battery packaging material 1 is heated and pressurized, the use of three types of solid fine particles different in hardness can suppress the increase in the adhesive force due to heating and pressurization to maintain the easy peeling property.

The total content rate of the solid fine particles 22 in the substrate protective layer 20 is regulated to be 30 mass % to 50 mass %. When the total content rate of the solid fine particles 22 is less than 30 mass %, the protrusion 30 on the surface of the substrate protective layer 20 becomes low in height and less in number, increasing the adhesion of the protective tape and the peel strength, which causes adhesive residue to occur more easily. On the other hand, when the total content rate of the solid fine particles exceeds 50 mass %, adhesive residue is less likely to occur, but the adhesion of the protective tape is reduced, making it easier for the tape to cause unintentional peeling during handling. The particularly preferred total content rate is 35 mass % to 45 mass %.

The preferred content rate of each fine particles in the substrate protective layer 20 is 1 mass % to 10 mass % for the soft resin fine particles 22a, 1 mass % to 20 mass % for the hard resin fine particles 22b, and 20 mass % to 40 mass % for the inorganic fine particles 22c. The particularly preferred content rate of each of the fine particles is 2 mass % to 8 mass % for the soft resin fine particles 22a, 3 mass % to 12 mass % for the hard resin fine particles 22b, and 25 mass % to 35 mass % for the inorganic fine particles 22c.

The soft resin fine particles 22a and the hard resin fine particles 22b are preferably 1 mass % or more in the content rate to improve the adhesion by increasing the contact area with the protective tape adhesive through deformation by heating and pressurization. On the other hand, when the soft resin fine particles 22a exceed 10 mass % in the content rate, and the hard resin fine particles 22b exceed 20 mass % in the content rate, the contact area between these resin fine particles 22a and 22b and the adhesive becomes excessive, and therefore, adhesive residue is more likely to occur when peeling off the protective tape. For this reason, it is preferable that the content rate be 10 mass % or less for the soft resin fine particles 22a, and the content rate be 20 mass % or less for the hard resin particles 22b.

The inorganic fine particles 22c hardly deform by heating and pressurizing and form micro unevenness (“micro cavities”) to suppress the contact area with the protective tape adhesive and maintain the easy peeling property, so it is preferable that the content rate be 20 mass % or more. On the other hand, when the inorganic fine particles 22c exceed 40 mass %, micro unevenness (micro cavities) become excessive, resulting in reduced bonding properties, which may lead to unintentional peeling. Therefore, it is preferable that the content rate be 40 mass % or less for the inorganic fine particles 22c.

Further, the relation between the content rates of the three types of solid fine particles is preferable such that the inorganic fine particles 22c is greater than the total of the soft resin fine particles 22a and the hard resin fine particles 22b. By blending more inorganic fine particles 22c, it is more effective in inhibiting the contact between the adhesive of the protective tape and the binder resin during heating and pressurization, which in turn can suppress the occurrence of adhesive residue.

Note that the total content rate of the solid fine particles 22 and the content rate of each solid fine particle are ratios to the total of the binder resin 21 and the solid fine particles 22 and do not include the solvent used to adjust the viscosity during coating. Since the content rate of the solid fine particles 22 in the substrate protective layer 20 is regulated to be 30 mass % to 50 mass %, the content rate of the binder resin 21 is 50 mass % to 70 mass %.

The soft resin fine particles 22a are responsible for increasing the contact area with the adhesive of the protective tape by deforming due to heating and pressurizing and effectively increase the area after deformation. Therefore, the soft resin fine particles are preferred to have the largest particle diameter among the three types of fine particles. The hard resin fine particles 22b are less deformable than the soft resin fine particles 22a, but they deform correspondingly to contribute to the contact area, and therefore, it is preferable that the hard resin fine particles be second in size to the soft resin fine particles 22a. The inorganic fine particles 22c have the role of reducing the contact area with the adhesive by means of micro cavities (micro unevenness) without deforming in order to maintain the protrusion of the fine particles to maintain the easy peeling property. Therefore, it is preferable that the particle diameter be the smallest.

In view of the above, the average particle diameter of the soft resin fine particles 22a is preferably 5 μm to 20 μm, the average particle diameter of the hard resin fine particles 22b is preferably 1 μm to 15 μm, and the average particle diameter of the inorganic fine particles 22c is preferably 1 μm to 5 μm. The particularly preferred average particle diameter is 6 μm to 18 μm for the soft resin fine particles 22a, 3 μm to 12 μm for the hard resin fine particles 22b, and 1 μm to 3 μm for the inorganic fine particles 22c. The contact area of the protective tape with the adhesion differs depending on the particle size of the solid fine particles, and therefore, the adhesive force differs. Thus, by setting the average particle diameters of the three types of solid fine particles within the above-described ranges, the timing at which the adhesive is peeled off shifts, resulting in less cohesive breakdown of the adhesive, which is less likely to cause the occurrence of adhesive residue.

Further, the average particle diameter of the three types of solid fine particles is preferred to meet the following relation: soft resin fine particles 22a≥hard resin fine particles 22b>inorganic fine particles 22c. As described above, the heating and pressurizing for battery curing deforms the soft resin fine particles 22a and the hard resin fine particles 22b into a flat shape, increasing their contact area with the adhesive of the protective tape to enhance the adhesive force, and the inorganic fine particles 22c are not deformed, which has the effect of suppressing deformation of the two types of resin fine particles. When the average particle diameter of the three types of solid particles satisfies the above-described relation, the balance between the adhesive force and the easy peeling properties becomes good, which suppresses the occurrence of adhesive residue.

It is required that the solid fine particles 22 contain at least one of each category of the soft resin fine particles 22a, the hard resin fine particles 22b, and the inorganic fine particles 22c, and may contain two or more from one category. Further, the followings can be exemplified as fine particles belonging to each category.

As the soft resin fine particles 22a, polyethylene wax, polypropylene wax, polyethylene resin beads, and urethane resin beads can be exemplified. These waxes or resin beads provide adequate peel strength to the adhesive of the protective tape due to the deformation strength thereof. Among the above-described soft resin fine particles 22a, polyethylene wax and polyethylene resin beads are low in glass transition point Tg and melting point, and the softening point of polyethylene is 85° C. to 120° C. Therefore, they soften and deform easily at around the temperature of the heating and pressurizing process (50° C. to 80° C.) during curing, so they are recommended in that they easily improve the peel strength with the adhesive of the protective tape.

As the hard resin fine particles 22b, polytetrafluoroethylene wax, acrylic resin beads, polystyrene resin beads, and fluororesin beads can be exemplified. These waxes or resin beads provide adequate peel strength to the adhesive of the protective tape due to the deformation strength thereof. Furthermore, all of these waxes or resin beads are 100° C. or therearound in glass transition point Tg and are unlikely to soften at the temperature (50° C. to 80° C.) of the heating and pressurizing process for curing after adhering the protective tape, but will slightly deform under the synergistic effect of pressure to slightly increase the contact area with the adhesive of the protective tape, which contributes to the peel strength.

Furthermore, among the above-described hard resin fine particles, polytetrafluoroethylene wax is preferred because it has excellent heat resistance and is less deformable after heat sealing, resulting in less change in gross after heat sealing and less reduction in slipperiness.

As the inorganic fine particles 22c, silica, alumina, kaolin, calcium oxide, calcium carbonate, calcium sulfate, barium sulfate, and calcium silicate can be exemplified. These inorganic fine particles 22c are all harder than the soft resin fine particles 22a and the hard resin fine particles 22b described above, and their breaking strength prevents them from being deformed in the heating and pressurizing process, thus providing appropriate peel strength to the adhesive of the protective tape. Further, among these inorganic fine particles 22c, silica is recommended because it is available in grades with small average particle diameters, and it is easy to obtain fine particles of a desired average particle size and disperse in a variety of binder resins.

As the binder resin 21, it is preferable to use at least one resin selected from the group consisting of an acrylic-based resin, a urethane-based resin, a polyolefin-based resin, a phenoxy-based resin, a polyester-based resin, and a tetrafluoroolefin-based resin. These resins have good adhesion suitability with the adhesive of the protective tape, so it is possible to differentiate the adhesive force between the area where the binder resin 21 is present and the area where the solid fine particles 22 are present. Further, these resins have high chemical resistance and solvent resistance, making it difficult for the solid fine particles 22 to drop out due to deterioration of the resin.

Furthermore, the binder resin 21 may be composed of a base resin containing at least one of the above-described resins and a curing agent for curing the base resin.

As the base resin, an acryl polyol resin, a urethane polyol resin, a polyolefin polyol resin, a polyester polyol resin, a phenoxy-based resin, a copolymer of tetrafluoro olefin and carboxylic acid vinylester, and a copolymer of tetrafluoro olefin and alkyl vinyl ether can be exemplified. One or more of them can be used in combination. Among them, the preferred base resins are a urethane polyol resin, a polyester polyol resin, an acrylic polyol resin, and a phenoxy-based resin. However, when prioritizing the prevention of poor appearance due to electrolyte adhesion, a copolymer of tetrafluoro-olefin and carboxylic acid vinylester or a copolymer of tetrafluoro-olefin and alkyl vinyl ether is preferred.

Although not particularly limited, the curing agent may be selected according to the base resin. As the curing agent, an isocyanate compound, such as, e.g., hexamethylene diisocyanate (HDI), isophorone diisocyanate (IPDI), tolylene diisocyanate (TDI), diphenylmethane diisocyanate (MDI), and xylylene diisocyanate (XDI), or a modified form of these isocyanate compounds can be exemplified. Isocyanate compounds, such as, e.g., tolylene diisocyanate (TDI), diphenylmethane diisocyanate (MDI), and xylylene diisocyanate (XDI), or a modified product of these isocyanates can be exemplified.

The curing agent is preferably blended from 5 parts by mass to 30 parts by mass with respect to 100 parts by mass of the base resin. If it is less than 5 parts by mass, the adhesion to the substrate layer 13 and the solvent resistance may deteriorate. Further, if it exceeds 30 parts by mass, the substrate protective layer 20 may become harder, resulting in reduced moldability.

Further, in addition to the binder resin 21 and the solid fine particles 22, a lubricant and/or a surfactant may be added to the substrate protective layer 20. A lubricant and a surfactant have an effect of reducing the adhesive force of the adhesive of the protective tape, and their deposition on the surface of the substrate protective layer 20 improves the peeling properties of the protective tape, making it less likely to cause the occurrence of adhesive residue.

As the lubricant, the following various amides can be exemplified.

As the saturated fatty acid amide, lauramide, palmitamide, stearamide, behenamide, and hydroxystearamide can be exemplified.

As the unsaturated fatty acid amide, an oleamide and an erucamide can be exemplified.

As the substituted amide, an N-oleoyl palmitamide, an N-stearyl stearamide, an N-stearyl oleamide, N-oleyl stearamide, and N-stearyl erucamide can be exemplified.

As the methylolamide, a methylolstearamide can be exemplified.

As the saturated fatty acid bisamide, a methylenebisstearamide, an ethylenebiscaprinamide, an ethylenebislauramide, an ethylene bisstearamide, an ethylenebishydroxystearamide, an ethylenebisbehenamide, a hexamethylene bisstearamide, a hexamethylenebisbehenamide, a hexamethylenebishydroxystearamide, an N,N′-distearyladipamide, an N,N′-distearylsebacinamide, and an N,N′-distearylsebacinamide can be exemplified.

As the unsaturated fatty acid bisamide, an ethylenebisoleamide, an ethylenebisercamide, a hexamethylenebisoleamide, an N,N′-dioleoyladipamide, and an N,N′-dioleoylsebacinamide can be exemplified.

As the fatty acid ester amide, stearamide ethyl stearate can be exemplified.

As the aromatic bisamide, an m-xylylene bisstearamide, an m-xylylene bishydroxystearamide, an N,N′-cysteallylisophthalic acid amide, and an N,N′-cysteallyl isophthalic acid amide can be exemplified.

Furthermore, as the surfactant, an anionic surfactant, a cationic surfactant, and a nonionic surfactant can be exemplified.

The preferred thickness of the substrate protective layer 20 is 1 μm to 12 μm, and the particularly preferred thickness thereof is 2 μm to 10 μm.

In the battery packaging material 1 described above, the preferred materials for the layers other than the substrate protective layer 20 are as follows.

### (Barrier Layer)

The barrier layer 11 is responsible for providing the battery packaging material 1 with gas barrier properties that prevent the intrusion of oxygen and moisture. As the barrier layer 11, although not particularly limited, a metal foil, such as, e.g., an aluminum foil, a SUS foil (stainless steel foil), a copper foil, a nickel foil, a titanium foil, and a clad foil, can be exemplified. As the barrier layer 11, an aluminum foil can be suitably used. In particular, an Al—Fe based alloy foil containing 0.7 mass % to 1.7 mass % of Fe has excellent strength and ductility and provides good moldability. The thickness of the barrier layer 11 is preferably 20 μm to 100 μm. A thickness of 20 μm or more can prevent the occurrence of pinholes during rolling when producing a metallic foil, and a thickness of 100 μm or less can reduce the stress during molding, such as, e.g., stretch forming and drawing, which can improve the moldability. The particularly preferred thickness of the barrier layer 11 is 30 μm to 80 μm.

Further, the barrier layer 11 is preferably subjected to a surface preparation, such as, e.g., a conversion treatment, on at least the heat-fusible resin layer 15 side of the metallic foil. Such a chemical conversion treatment sufficiently prevents corrosion of the metal foil surface due to the contents (electrolyte of batteries, etc.).

### (Substrate Layer)

As the substrate layer 13, a heat-resistant resin film that does not melt at the heat-sealing temperature when heat-sealing the battery packaging material 1 is used. As the heat-resistant resin, a heat-resistant resin having a melting point higher than the melting point of the resin constituting the heat-fusible resin layer 15 by 10° C. or more, preferably 20° C. or more. As the resin that meets these conditions, a polyamide film, such as, e.g., a nylon film and a polyester film, can be exemplified, and these stretched films are preferably used. Among them, as the substrate layer 13, it is particularly desirable to use a biaxially stretched polyamide film, such as, e.g., a biaxially stretched nylon film, a biaxially stretched polybutylene terephthalate (PBT) film, a biaxially stretched polyethylene terephthalate (PET) film, and a biaxially stretched polyethylene naphthalate (PEN) film. As the nylon film, although not particularly limited, a 6 nylon film, a 6,6 nylon film, an MXD nylon film, etc., can be exemplified.

Note that the substrate layer 13 may be formed as a single layer. Alternatively, it may be formed, for example, as a multiple layer composed of a polyester film/a polyamide film (e.g., a multiple layer, etc., composed of a PET film/a nylon film).

The thickness of the substrate layer 13 is preferably 9 μm to 50 μm, which can ensure sufficient strength as a packaging material and reduce the stress during molding, such as, e.g., stretch forming and drawing, thereby improving the moldability. The more preferred thickness of the substrate layer 13 is 12 μm to 30 μm.

### (Heat-Fusible Resin Layer)

The heat-fusible resin layer 15 is responsible for providing the battery packaging material 1 with excellent chemical resistance to highly corrosive electrolytes and other substances, as well as for providing the battery packaging material 1 with heat sealing properties.

The resin constituting the heat-fusible resin layer 15 is preferably a single-layer film or a multi-layer film of a polyolefin-based resin, such as, e.g., a propylene-based resin, and a non-stretched film thereof is preferred. As the propylene-based resin, an ethylene-propylene copolymer containing ethylene and propylene as copolymerization components can be exemplified. The ethylene-propylene copolymer may be either a random copolymer or a block copolymer. As the multilayer ethylene-propylene copolymer film, a three-layer film of random copolymer-block copolymer-random copolymer can be recommended. The multilayer film can be produced by co-extrusion or other methods.

The thickness of the heat-fusible resin layer 15 is preferably 20 μm to 100 μm, more preferably 30 μm to 80 μm. Further, the thickness ratio of each layer of the three-layer film made of a random copolymer-a block copolymer-a random copolymer is preferably 1-3:4-8:1-3.

The heat-fusible resin layer 15 may contain a lubricant. As for the type of the lubricant, it is particularly preferable to use a fatty acid amide, similar to the one added to the substrate protective layer 20. Further, the concentration of the lubricant in the heat-fusible resin layer 15 is preferably 500 ppm to 3,000 ppm. Generally, in the production process of the battery packaging material 1, all the layers are laminated and then rolled up and aged. The lubricant in the heat-fusible resin layer 15 is deposited on the surface and transferred to the substrate protective layer 20 by aging, contributing to the prevention of adhesive residue on the protective tape.

### (First Adhesive Layer)

Although not particularly limited, the first adhesive layer 12 can be exemplified by an adhesive layer made of a two-part curing type adhesive. As the two-part curing type adhesive, it may be exemplified by a two-part curing type adhesive composed of a first liquid (main agent) composed of one or more polyols selected from the group consisting of a polyurethane-based polyol, a polyester-based polyol, a polyether-based polyol, and a polyester urethane-based polyol, and a second liquid (curing agent) composed of an isocyanate. Among them, it is preferably to use a two-part curing type adhesive made of a first liquid composed of one or more polyols selected from the group consisting of a polyester-based polyol and a polyester urethane-based polyol, and a second liquid (curing agent) composed of isocyanate. The preferred thickness of the first adhesive layer 12 is 2 μm to 5 μm.

### (Second Adhesive Layer)

Although not particularly limited, the second adhesive layer 14 can be recommended to use, for example, an adhesive containing one or more of resins consisting of a polyurethane-based resin, an acrylic-based resin, an epoxy-based resin, a polyolefin-based resin, an elastomer-based resin, a fluorine-based resin, and an acid-modified polypropylene resin. Among them, it is preferred to use an adhesive composed of a polyurethane composite resin with an acid-modified polyolefin as the main agent. The preferred thickness of the second adhesive layer 14 is 2 μm to 5 μm.

The first adhesive layer 12 and the second adhesive layer 14 are not essential layers. The substrate layer 13 may be directly adhered to the barrier layer 11, or the heat-fusible resin layer 15 may be directly adhered to the barrier layer 11.

### (Coloring Agent and Coloring Layer)

In the battery packaging material, by adding a coloring agent to the above-described existing layer or by newly adding a coloring layer, it is possible to conceal the metallic color of the barrier layer and color the battery packaging material to a desired color to thereby impart a design to the packaging material, and also possible to make it easier to detect adhesive residue remained on the protective tape.

In the case of coloring an existing layer, a coloring agent is added to at least one of the substrate protective layer 20, the substrate layer 13, and the first adhesive layer 12. Note that in a battery packaging material 1 with no first adhesive layer, a coloring agent is added to the substrate protective layer 20 and/or the substrate layer 13. The coloring agent may be either a pigment or a dye and may be one type of a coloring agent or a combination of two or more types of coloring agents. As a specific coloring agent, carbon black, calcium carbonate, titanium dioxide, zinc oxide, iron oxide, aluminum powder, azo-based pigments, phthalocyanine-based pigments, etc., can be exemplified. The concentration of the coloring agent in each layer is preferably in the range of 0.5 mass % or more and less than 5 mass %.

In the case of newly adding a coloring layer, the coloring layer is added at least one of between the substrate protective layer 20 and the substrate layer 13, between the substrate layer 13 and the first adhesive layer 12, and between the first adhesive layer 12 and the barrier layer 11. Note that in a battery packaging material with no first adhesive layer, a coloring agent is added between the substrate protective layer and the barrier layer and/or between the substrate layer and the barrier layer. The thickness of the coloring layer is preferably 1 μm to 10 μm. Further, the coloring layer is preferably composed of a coloring resin composition in which the above-described coloring agent is added to a base resin composed of a main agent, such as, e.g., diamine and polyol, and a curing agent. Further, the concentration of the coloring agent in this coloring resin composition is preferably in the range of 5 mass % or more and 50 mass % or less.

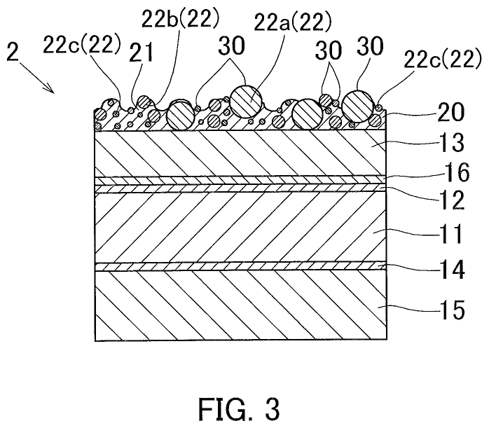

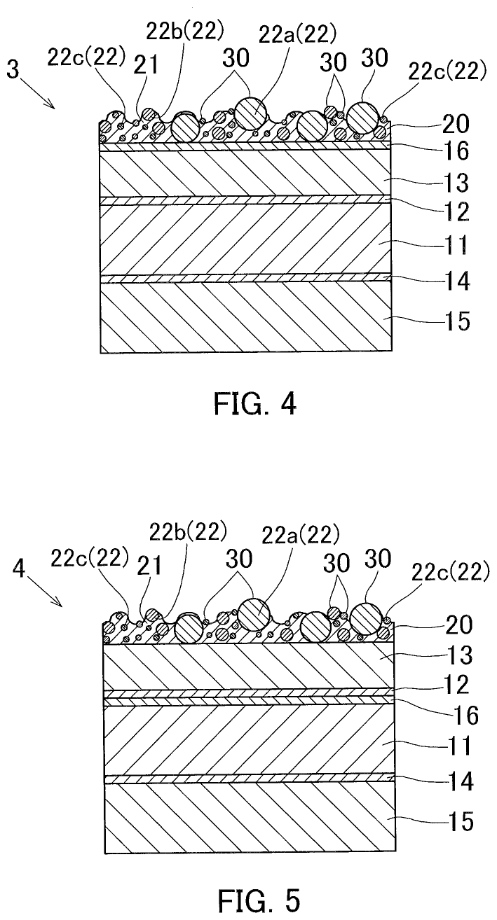

The battery packaging material 2 shown in FIG. 3 is provided with a coloring layer 16 between the substrate layer 13 and the first adhesive layer 12. The battery packaging material 3 shown in FIG. 4 is provided with a coloring layer 16 between the substrate protective layer 20 and the substrate layer 13. The battery packaging material 4 shown in FIG. 5 is provided with a coloring layer 16 between the first adhesive layer 12 and the barrier layer 11.

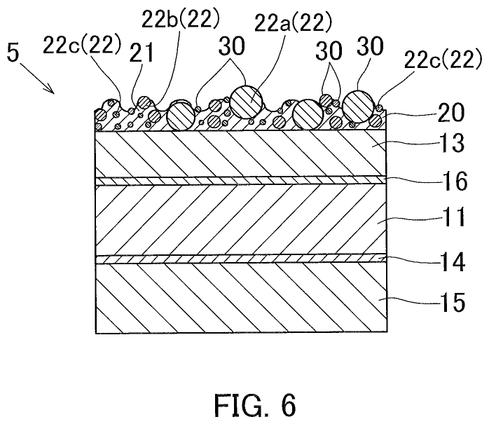

The battery packaging material 5 shown in FIG. 6 is not provided with a first adhesive layer 12, but is provided with a coloring layer 16 between the barrier layer 11 and the substrate layer 13. Note that even in a battery packaging material not having a first adhesive layer, a coloring layer may be provided between the substrate protective layer and the substrate layer.

### EXAMPLES

As Examples and Comparative Examples, battery packaging materials 2 with the structure shown in FIG. 3 were produced. The materials common to Examples are as follows.

### (Common Materials)

As the barrier layer 11, a layer was used in which a chemical conversion treatment solution composed of phosphoric acid, polyacrylic acid (acrylic-based resin), a chromium (III) salt compound, water, and alcohol was applied to both sides of an aluminum foil made of A8021-O with a thickness of 40 μm, and then dried at 180° C. to form a chemical conversion coating. The chromium adhesion amount of this chemical conversion coating was 10 mg/m² per one side.

As the substrate layer 13, a biaxially stretched 6-nylon film with a thickness of 15 μm was used.

As the coloring layer 16, a coloring resin composition containing carbon black, diamine, polyester-based polyol, and a curing agent was applied to one side of the substrate layer 13 and left in a 40° C. environment for one day to allow a cross-linking reaction to proceed as it dried, thereby forming a black coloring layer with a thickness of 3 μm. That is, the coloring layer 16 and the substrate layer 13 were integrated into a two-layer film, which is then laminated with other layers.

As the heat-fusible resin layer 15, a non-stretched polypropylene film with a thickness of 30 μm containing 3,000 ppm of erucamide as a lubricant was used.

As the first adhesive layer 12, a two-part curing type urethane-based adhesive was used.

As the second adhesive layer 14, a two-part curing type maleic acid-modified propylene adhesive was used.

As a solvent to be added to the resin composition of the substrate protective layer 20, a mixture of 50 parts by mass of methyl ethyl ketone and 50 parts by mass of tolylene was used.

### Example 1

A resin composition for forming the substrate protective layer 20 and a coating composition were prepared by the following method.

A polyester polyol resin was used as the base resin and an adduct of trimethylolpropane and hexamethylene diisocyanate (HDI) (denoted as “A” in Table 1) was used as the curing agent. 11 parts by mass of the curing agent was blended with 49 parts by mass of the base resin to prepare a binder resin.

For the solid fine particles, four types were used, i.e., polyethylene wax was used as soft resin fine particles, acrylic resin beads were used as hard resin fine particles, and silica and barium sulfate were used as inorganic fine particles. The average particle diameter of each of the solid fine particles, the deformation strength of the soft resin fine particles and that of the hard resin fine particles, and the breaking strength of the inorganic fine particles are shown in Table 1.

The resin composition was prepared by blending four types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

Then, a first adhesive layer 12 with a thickness of 3 μm was formed on one side of the barrier layer 11, and the substrate layer 13 (two-layer film) with a coloring layer 16 was overlaid and dry-laminated via the first adhesive layer 12. Next, a second adhesive layer 14 with a thickness of 3 μm was formed on the other side of the barrier layer 11, and a heat-fusible resin layer 15 was overlaid via this second adhesive layer 14 and dry-laminated by sandwiching it between a rubber nip roll and a laminate roll heated to 100° C. and crimping it. This resulted in a six-layer film composed of a substrate layer 13, a coloring layer 16, a first adhesive layer 12, a barrier layer 11, a second adhesive layer 14, and a heat-fusible resin layer 15, in order from the outside to the inside.

Next, the coating composition for the substrate protective layer 20 was applied to the surface of the substrate layer 13 of the above-described 6-layer laminated film, dried, rolled, and aged at 40° C. for 10 hours. The thickness of the substrate protective layer 20 after aging was 2.5 μm, resulting in a 7-layer battery packaging material 2.

### Example 2

A resin composition for forming the substrate protective layer 20 and a coating composition were prepared by the following method.

The same base resin and curing agent as in Example 1 were blended in a ratio of 48 parts by mass of the base resin to 10 parts by mass of the curing agent to prepare a binder resin.

For the solid fine particles, four types were used, i.e., polyethylene wax was used as soft resin fine particles, polystyrene resin beads were used as hard resin fine particles, and silica and barium sulfate were used as inorganic fine particles. The average particle diameter of each of the solid fine particles, the deformation strength of the soft resin fine particles and that of the hard resin fine particles, and the breaking strength of the inorganic fine particles are shown in Table 1.

The resin composition was prepared by blending four types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 2.5 μm.

### Example 3

A resin composition and a coating composition for forming the substrate protective layer 20 were prepared by the following method.

An acrylic polyol was used as the base resin, and the same curing agent as in Example 1 was used to prepare a binder resin in which 9 parts by mass of the curing agent was blended with 46 parts by mass of the base resin.

For the solid fine particles, four types were used, i.e., polyethylene resin beads were used as soft resin fine particles, polytetrafluoroethylene wax was used as hard resin fine particles, and alumina and barium sulfate were used as inorganic fine particles. The average particle diameter of each of the solid fine particles, the deformation strength of the soft resin fine particles and the hard resin fine particles, and the breaking strength of the inorganic fine particles are shown in Table 1.

The resin composition was prepared by blending four types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 2 μm.

### Example 4

A resin composition and a coating composition for forming the substrate protective layer 20 were prepared by the following method.

A copolymer of tetrafluoro-olefin and vinyl ester carboxylate was used as the main agent, and the same curing agent as in Example 1 was used as the binder resin to prepare a binder resin in which 43 parts by mass of the main agent resin were mixed with 8 parts by mass of the curing agent.

For the solid fine particles, four types were used, i.e., polyethylene resin beads were used as soft resin fine particles, polytetrafluoroethylene wax was used as hard resin fine particles, and silica and barium sulfate were used as inorganic fine particles. The average particle diameter of each of the solid fine particles, the deformation strength of the soft resin fine particles and the hard resin fine particles, and the breaking strength of the inorganic fine particles are shown in Table 1.

The resin composition was prepared by blending four types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 1.5 μm.

### Example 5

A resin composition and a coating composition for forming the substrate protective layer 20 were prepared by the following method.

The same base resin and curing agent as in Example 1 were used to prepare a binder resin in which 53 parts by mass of the base resin were mixed with 12 parts by mass of the curing agent.

For the solid fine particles, four types were used, i.e., polyethylene wax was used as soft resin fine particles, polystyrene resin beads were used as hard resin fine particles, and alumina and calcium carbonate were used as inorganic fine particles. The average particle diameter of each of the solid fine particles, the deformation strength of the soft resin fine particles and the hard resin fine particles, and the breaking strength of the inorganic fine particles are shown in Table 1.

The resin composition was prepared by blending four types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 3 μm.

### Example 6

A resin composition and a coating composition for forming the substrate protective layer 20 were prepared by the following method.

A polyurethane polyol resin was used as the base resin, and a mixture of equal parts of an adduct of trimethylolpropane and hexamethylene diisocyanate (HDI) and an adduct of trimethylolpropane and toluene diisocyanate (TDI) (referred to as “B” in Table 1) was used as the curing agent. A binder resin was prepared in which 10 parts by mass of the curing agent was mixed with 46 parts by mass of the binder resin.

For the solid fine particles, four types were used, i.e., urethane resin beads were used as soft resin fine particles, acrylic resin beads were used as hard resin fine particles, and silica and barium sulfate were used as inorganic fine particles. The average particle diameter of each of the solid fine particles, the deformation strength of the soft resin fine particles and the hard resin fine particles, and the breaking strength of the inorganic fine particles are shown in Table 1.

The resin composition was prepared by blending four types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 2 μm.

### Example 7

A resin composition and a coating composition for forming the substrate protective layer 20 were prepared by the following method.

The same binder resin as in Example 1 was used.

As the solid fine particles, the same soft resin fine particles and hard resin fine particles as in Example 1 were used, and three types of silica were used as the inorganic fine particles. The average particle diameter of each of the solid fine particles, the deformation strength of the soft resin fine particles and the hard resin fine particles, and the breaking strength of the inorganic fine particles are shown in Table 1.

A resin composition was prepared by blending three types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 2.5 μm.

### Comparative Example 1

A resin composition and a coating composition for forming the substrate protective layer 20 was prepared by the following method.

The same base resin and curing agent as in Example 1 were used to prepare a binder resin in which 60 parts by mass of the base resin were mixed with 12 parts by mass of the curing agent.

For the solid fine particles, four types were used, i.e., polypropylene wax was used as soft resin fine particles, polystyrene resin beads were used as hard resin fine particles, and silica and barium sulfate were used as inorganic fine particles. The average particle diameter of each of the solid fine particles, the deformation strength of the soft resin fine particles and the hard resin fine particles, and the breaking strength of the inorganic fine particles are shown in Table 1.

A resin composition was prepared by blending four types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 3 μm.

### Comparative Example 2

A resin composition and a coating composition for forming the substrate protective layer 20 was prepared by the following method.

The same base resin and curing agent as in Example 3 were used to prepare a binder resin in which 37 parts by mass of the base resin were mixed with 8 parts by mass of the curing agent.

For the solid fine particles, four types were used, i.e., polyethylene wax was used as soft resin fine particles, acrylic resin beads were used as hard resin fine particles, and alumina and barium sulfate were used as inorganic fine particles. The average particle diameter of each of the solid fine particles, the deformation strength of the soft resin fine particles and the hard resin fine particles, and the breaking strength of the inorganic fine particles are shown in Table 1.

A resin composition was prepared by blending four types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 2 μm.

### Comparative Example 3

A resin composition and a coating composition for forming the substrate protective layer 20 was prepared by the following method.

The same binder resin as in Example 1 was used. For the solid fine particles, without using soft resin fine particles, three types solid fine particles were used, i.e., acrylic resin beads were used as hard resin fine particles, and silica and barium sulfate were used as inorganic fine particles. The average particle diameter of each of the solid fine particles, the deformation strength of the hard resin fine particles and the breaking strength of the inorganic fine particles are shown in Table 1.

A resin composition was prepared by blending three types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 2.5 μm.

### Comparative Example 4

A resin composition and a coating composition for forming the substrate protective layer 20 was prepared by the following method.

The same binder resin as in Example 1 was used.

For the solid fine particles, without using hard resin fine particles, three types of inorganic fine particles, i.e., polyethylene wax as soft resin fine particles, silica and barium sulfate as inorganic fine particles were used. The average particle diameter, the deformation strength of the hard resin fine particles, and the breaking strength of the inorganic fine particles of each of the solid fine particles are shown in Table 1.

A resin composition was prepared by blending three types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 2.5 μm.

### Comparative Example 5

A resin composition and a coating composition for forming the substrate protective layer 20 was prepared by the following method.

The same binder resin as in Example 1 was used.

For the solid fine particles, three types were used, i.e., polyethylene wax was used as soft resin fine particles, acrylic resin beads were used as hard resin fine particles, and barium sulfate were used as inorganic fine particles. The average particle diameter, the deformation strength of the soft resin fine particles and the hard resin fine particles, and the breaking strength of the inorganic fine particles of each of the solid fine particles are shown in Table 1.

A resin composition was prepared by blending three types of solid fine particles with the above-described binder resin at the content rates shown in Table 1, and the coating composition was further prepared by mixing 50 parts by mass of the above-described resin composition with 100 parts by mass of a solvent. The total content rate of the solid fine particles in the above-described resin composition is shown in Table 1.

A battery packaging material 2 with a seven-layer structure was prepared using the same method as in Example 1, except for the resin composition and the coating composition for the substrate protective layer 20 described above. The thickness of the substrate protective layer 20 after aging was 2.5 μm.

TABLE 1

| | | Substrate protective layer Resin composition | | | | | | | | | |
|---|---|---|---|---|---|---|---|---|---|---|---|
| | | | | Solid fine particles | | | | | | | |
| | | | | Soft resin fine particles | | | | Hard resin fine particles | | | |
| | | | | | Deforma- | Average | Content | | Deforma- | Average | Content |
| | | Binder resin | | | tion | Particle | rate | | tion | Diameter | rate |
| | | Base | Curing | | strength | Diameter | Mass | | strength | Particle | Mass |
| | | resin | agent | Type | Mpa | μm | % | Type | MPa | μm | % |
| Ex. | 1 | PEs | A | PEW | 5.3 | 10 | 3 | ACB | 41 | 5 | 5 |
| | 2 | PEs | A | PEW | 5.3 | 10 | 5 | PSB | 22 | 10 | 11 |
| | 3 | AC | A | PEB | 5.4 | 12 | 8 | PTFE | 58 | 10 | 5 |
| | 4 | TFE | A | PEB | 5.1 | 15 | 6 | PTFE | 53 | 12 | 4 |
| | 5 | PEs | A | PEW | 6.5 | 8 | 3 | PSB | 26 | 4 | 5 |
| | 6 | PUR | B | URB | 3.2 | 16 | 6 | ACB | 36 | 10 | 10 |
| | 7 | PEs | A | PEW | 5.3 | 10 | 3 | ACB | 41 | 5 | 5 |
| Compar- | 1 | PEs | A | PPW | 8.1 | 8 | 2 | PSB | 27 | 3 | 5 |
| ative | 2 | AC | A | PEW | 4.5 | 18 | 12 | ACB | 33 | 12 | 10 |
| Ex. | 3 | PEs | A | | | | | ACB | 41 | 5 | 3 |
| | 4 | PEs | A | PEW | 5.3 | 10 | 3 | | | | |
| | 5 | PEs | A | PEW | 5.3 | 10 | 3 | ACB | 41 | 5 | 5 |

| | | Substrate protective layer Resin composition | | | | | | | | | | | |
|---|---|---|---|---|---|---|---|---|---|---|---|---|---|
| | | Solid fine particles | | | | | | | | | | | |
| | | | | | | Inorganic fine particles 2 | | | | | | | |
| | | Inorganic fine particles 1 | | | | | | | | Total | | | |
| | | | Break- | Average | Content | | Break- | Average | Content | content | Performance evaluation | | |
| | | | ing | Particle | rate | | ing | Particle | rate | rate | | | Ad- |
| | | | Strength | Diameter | Mass | | strength | Diameter | Mass | Mass | Moulda- | Tape | hesive |
| | | Type | MPa | μm | % | Type | Mpa | μm | % | % | bility | Adhesion | residue |
| Ex. | 1 | Sili- | 1450 | 1 | 22 | Ba | 1280 | 2 | 5 | 35 | ⊚ | ⊚ | ⊚ |
| | | ca | | | | sulfate | | | | | | | |
| | 2 | Sili- | 1450 | 1 | 6 | Ba | 1280 | 2 | 16 | 38 | ⊚ | ⊚ | ⊚ |
| | | ca | | | | sulfate | | | | | | | |
| | 3 | Alu- | 1830 | 2 | 20 | Ba | 1280 | 2 | 10 | 43 | ⊚ | ⊚ | ⊚ |
| | | mina | | | | sulfate | | | | | | | |
| | 4 | Sili- | 1450 | 1 | 10 | Ba | 1310 | 1 | 25 | 45 | ⊚ | ⊚ | ⊚ |
| | | ca | | | | sulfate | | | | | | | |
| | 5 | Alu- | 1890 | 1 | 16 | Ca | 820 | 2 | 7 | 31 | ◯ | ⊚ | ◯ |
| | | mina | | | | sulfate | | | | | | | |
| | 6 | Sili- | 1450 | 1 | 12 | Ba | 1240 | 3 | 20 | 48 | ⊚ | ◯ | ⊚ |
| | | ca | | | | sulfate | | | | | | | |
| | 7 | Sili- | 1450 | 1 | 27 | | | | | 35 | ⊚ | ⊚ | ⊚ |
| | | ca | | | | | | | | | | | |
| Compar- | 1 | Sili- | 1450 | 1 | 6 | Ba | 1310 | 1 | 12 | 25 | X | ⊚ | X |
| ative | | ca | | | | sulfate | | | | | | | |
| Ex. | 2 | Alu- | 1830 | 2 | 15 | Ba | 1310 | 1 | 18 | 55 | ⊚ | X | ⊚ |
| | | mina | | | | sulfate | | | | | | | |
| | 3 | Sili- | 1450 | 1 | 20 | Ba | 1280 | 2 | 5 | 28 | X | X | X |
| | | ca | | | | sulfate | | | | | | | |
| | 4 | Sili- | 1450 | 1 | 20 | Ba | 1280 | 2 | 5 | 28 | X | ⊚ | Δ |
| | | ca | | | | sulfate | | | | | | | |
| | 5 | | | | | Ba | 1280 | 2 | 5 | 13 | X | ⊚ | X |
| | | | | | | sulfate | | | | | | | |

In Table 1, the abbreviations for the base resin, the soft resin fine particles and the hard resin fine particles are as follows

### (Base Resin)

PEs: Polyester polyol resin
AC: Acrylic polyol resin
TFE: Copolymer of tetrafluoroethylene and carboxylic acid
vinyl ester
PUR: Polyurethane polyol resin

### (Soft Resin Fine Particles)

PEW: Polyethylene wax
PEB: Polyethylene resin beads
URB: Urethane resin beads
PPW: Polypropylene wax

### (Hard Resin Fine Particles)

ACB: Acrylic resin beads
PTFE: Polytetrafluoroethylene wax
PSB: Polystyrene resin beads

### [Strength of Solid Fine Particles]

The deformation strength of the soft resin fine particles and the hard resin fine particles used in each case and the breaking strength of the inorganic fine particles were measured in accordance with JIS Z 8844: 2019 Method for measuring breaking strength and deformation strength of fine particles, using a dynamic ultra-micro hardness tester (Model No.: DUH-211) manufactured by Shimadzu Corp. and actual values measured using the SHIMAZU MCT application (software).

The measurement was performed by continuously loading one sampled particle with a 50 μm Φ flat indenter at a test force of 10 mN, a loading speed of 0.1463 mN/sec, and a load holding time of 3 sec. The obtained load-displacement relation and the particle diameter measured using a simple length measuring function of a CMOS camera image were used to obtain the deformation strength and breaking strength. Further, five measurements were performed for each type of solid fine particle, and the average value was taken as the strength of the solid fine particle.

### [Evaluation of Battery Packaging Material]

The following items were measured and evaluated for each of the prepared battery packaging materials 2. The results are shown in Table 1.

### (Moldability)

A plurality of test pieces of 100 mm×125 mm were cut from the prepared battery packaging material 2. For these test pieces, using a molding machine (part number: TP-25C-XZ) manufactured by Amada Co., deep drawing was performed on these test piece using a punch with a top dimension of 33 mm×54 mm, a corner R of 2 mm, and a punch shoulder R of 1.3 mm and a die with a die shoulder R of 1 mm, at different depths.

Deep-drawn molded products were examined for pinholes and cracks at the corners by the light transmission method in a dark room, and the depth at which no pinholes or cracks occurred was defined as the maximum molding depth (mm) of the battery packaging material 2. The maximum molding depth was evaluated based on the following evaluation criteria, with ⊚ and ◯ being accepted.
⊚: Maximum molding depth is 5.5 mm or more
◯: Maximum molding depth is 4.5 mm or more and less than 5.5 mm
X: Maximum molding depth is less than 4.5 mm.

### (Tape Adhesion)

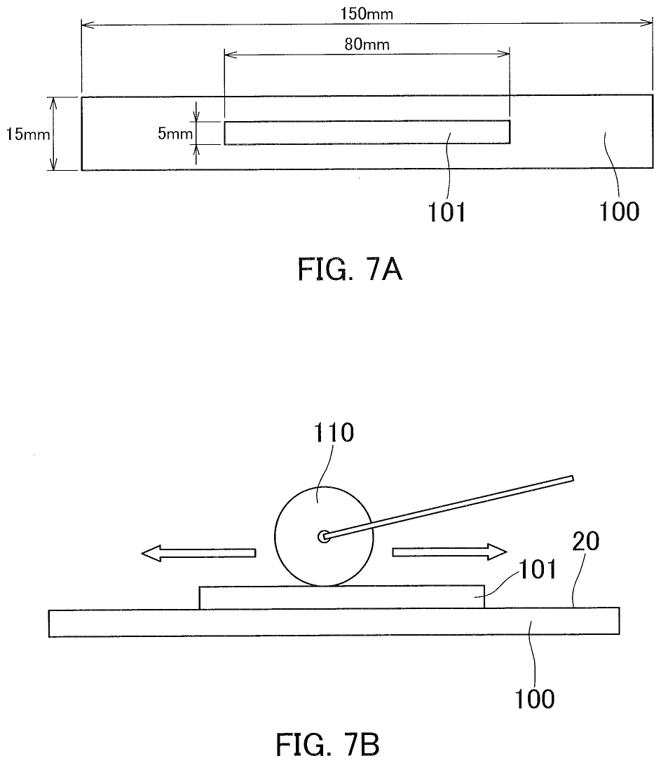

FIGS. 7A and 7B schematically show the test method.

A test piece 100 of 15 mm wide×150 mm long was cut from the battery packaging material 2. An adhesive tape (tesa 70415) 101 with a width of 5 mm×length of 80 mm and an adhesive force of 13 N/cm was adhered to the substrate protective layer 20 of the test piece 100 along the longitudinal direction of the test piece 100. Then, a hand roll 110 weighing 2 kgf was run back and forth 5 times on this adhesive tape 101, and then allowed to rest for 1 hour at room temperature.

Next, a Shimadzu Strograf (AGS-5kNX) was used as the tensile testing machine, and one chuck was used to clamp and fix the end of the test piece 100, while the other chuck was used to grip the end of the adhesive tape 101. The peel strength was then measured when the tape was peeled 180° at a peel speed of 300 mm/min in accordance with JIS K6854-3 (1999), and the value at which this measurement value stabilized was used as the adhesive force (unit: N/5 mm) between the test piece 100 and the adhesive tape 101.

The adhesive forth between the test piece 100 and the adhesive tape 101 was then evaluated according to the following criteria, with ⊚ and ◯ being accepted.
⊚: 7 N/5 mm or more, with very high adhesion
◯: 5 N/5 mm or more and less than 7 N/5 mm, with high adhesion
X: Less than 5 N/5 mm, with low adhesion

### (Adhesive Residue)

A test piece of 50 mm wide×100 mm long was cut from the battery packaging material 2. An adhesive tape (Nito Denko V420) with a 40 mm width×60 mm long and an adhesive force of 0.1 N/cm was adhered to the substrate protective layer 20 of the test piece along the longitudinal direction of the test piece. Then, a hand roll weighing 2 kgf was run back and forth 5 times on this adhesive tape. Then, the test piece with the above adhesive tape attached was heat-pressed for 3 hours at 80° C.×0.5 MPa.

Then, the adhesive tape was quickly peeled off by hand from the test piece after a series of processes, the peeled surface was observed and evaluated based on the following criteria, with ⊚◯Δ being accepted.
⊚: No change at all in the surface condition as compared with before adhering the tape
◯: Small fragments of adhesive residue that could be removed by lightly wiping.
Δ: Adhesive residue could be wiped off, but larger fragments of the adhesive than the fragments shown with ◯ remained
X: Adhesive remained firmly to the degree that it could not be removed by wiping.

From Table 1, it was confirmed that by regulating the solid fine particles in the substrate protective layer, the adhesion of the protective tape is good and adhesive residue at peeling can be restrained.

### INDUSTRIAL APPLICABILITY

A battery packaging material of the present invention can be suitably used for a packaging material for a power storage device, such as, e.g., a battery and a capacitor, used for a mobile device including, e.g., a smartphone and a tablet computer. It also can be suitably used for a packaging material for a power storage device, such as, e.g., a battery and a condenser, used for an electric vehicle, wind power generation, solar power generation, and nighttime electricity storage.

This application claims priority to Japanese Patent Application No. 2022-135592 filed on Aug. 29, 2022, and Japanese Patent Application No. 2023-108176 filed on Jun. 30, 2023, the disclosure of which is incorporated by reference in its entirety.

It should be recognized that the terms and expressions used herein are for illustrative purposes only, are not to be construed as limiting, do not exclude any equivalents of the features shown and described herein, and allow for various variations within the claimed scope of this invention. It should be recognized that the invention does not exclude any equivalents of the features shown and described herein, but permits various variations within the claimed scope.

### DESCRIPTION OF REFERENCE SYMBOLS

1, 2: Battery packaging material
11: Barrier layer
12: First adhesive layer
13: Substrate layer
14: Second adhesive layer
15: Heat-fusible resin layer
16: Coloring layer
20: Substrate protective layer
21: Binder resin
22: Solid fine particles
22a: Soft resin fine particles
22b: Hard resin fine particles
22C: Inorganic fine particles
30: Protrusion

1. A battery packaging material comprising:
a substrate layer;
a heat-fusible resin layer;
a barrier layer arranged between the substrate layer and the heat-fusible resin layer; and
a substrate protective layer arranged on an outer side of the substrate layer as an outermost layer,
wherein the substrate protective layer contains a binder resin and solid fine particles, the solid fine particles including soft resin fine particles, hard resin fine particles, and inorganic fine particles,
wherein a deformation strength of the soft resin fine particles is 2 MPa or more and less than 20 MPa, a deformation strength of the hard resin fine particles is 20 MPa to 100 MPa, and a breaking strength of the inorganic fine particles is 500 MPa to 2,000 MPa, the deformation strength and the breaking strength being measured in accordance with a measurement method of a breaking strength and a deformation strength defined in JIS Z 8844:2019, and
wherein a total content rate of the solid fine particles in the substrate protective layer is 30 mass % to 50 mass %.

2. The battery packaging material as recited in claim 1,
wherein an average particle diameter of the soft resin fine particles is 5 μm to 20 μm, an average particle diameter of the hard resin fine particles is 1 μm to 15 μm, and an average particle diameter of the inorganic fine particles is 1 μm to 5 μm.

3. The battery packaging material as recited in claim 1,
wherein a content rate of the soft resin fine particles in the substrate protective layer is 1 mass % to 10 mass %, a content rate of the hard resin fine particles is 1 mass % to 20 mass %, and a content rate of the inorganic fine particles is 20 mass % to 40 mass %.

4. The battery packaging material as recited in claim 1,
wherein the soft resin fine particles are at least one selected from the group consisting of polyethylene wax, polypropylene wax, polyethylene resin beads, and urethane resin beads.

5. The battery packaging material as recited in claim 1,
wherein the hard resin particles are at least one selected from the group consisting of polytetrafluoroethylene wax, acrylic resin beads, polystyrene resin beads, and fluororesin beads.

6. The battery packaging material as recited in claim 1,
wherein the inorganic fine particles are at least one selected from the group consisting of silica, alumina, kaolin, calcium oxide, calcium carbonate, calcium sulfate, barium sulfate, and calcium silicate.

7. The battery packaging material as recited in claim 1,
wherein the binder resin is at least one selected from the group consisting of an acrylic-based resin, a urethane-based resin, a polyolefin-based resin, a phenoxy-based resin, a polyester-based resin, and a tetrafluoroolefin-based resin.

8. The battery packaging material as recited in claim 1,
wherein at least one of the substrate protective layer and the substrate layer contains a coloring agent.

9. The battery packaging material as recited in claim 1,
wherein the barrier layer and the substrate layer are laminated via an adhesive layer, and at least one of the substrate protective layer, the substrate layer, and the adhesive layer contains a coloring agent.

10. The battery packaging material as recited in claim 1,
wherein a coloring layer is arranged at least one of between the substrate protective layer and the substrate layer and between the substrate layer and the barrier layer.

11. The battery packaging material as recited in claim 1,
wherein the barrier layer and the substrate layer are laminated via an adhesive layer, and the coloring layer is arranged at least one of between the substrate protective layer and the substrate layer, between the substrate layer and the adhesive layer, and between the adhesive layer and the barrier layer.
